(19) United States
(12) Patent Application Publication
(10) Pub. No.: US 2014/0192070 A1
(43) Pub. Date: Jul. 10, 2014

(54) CONFIGURABLE IMAGE PROCESSING SYSTEM AND METHOD THEREOF

(71) Applicant: ALTEK CORPORATION, Hsinchu City (TW)

(72) Inventors: KUEI-HUNG CHENG, Zhubei City (TW); HSIN-HAN CHEN, Hsinchu City (TW); YEN-PING TENG, Tainan City (TW)

(73) Assignee: ALTEK CORPORATION, Hsinchu City (TW)

(21) Appl. No.: 13/754,973

(22) Filed: Jan. 31, 2013

(30) Foreign Application Priority Data
Jan. 8, 2013 (TW) 102100512

(51) Int. Cl. G06T 1/20

(52) U.S. Cl. CPC G06T 1/20
USPC 345/522

(57) ABSTRACT

The present invention discloses a configure image process system and a configure image process method thereof applicable to a predetermine image process structure. The configure image process system includes N pieces of logic hardware and a control module, wherein N is a positive integer. Each piece of the logic hardware respectively corresponds to an algorithm structure, and the control module connects to each piece of the logic hardware. The control module can selectively apply the N pieces of logic hardware to combine at least one part of the predetermine image process structure to perform the image process.

### CROSS-REFERENCE TO RELATED APPLICATION

This application claims the benefit of Taiwan Patent Application No. 102100512, filed on, Jan. 8, 2013, in the Taiwan Intellectual Property Office, the disclosure of which is incorporated herein in its entirety by reference.

### BACKGROUND OF THE INVENTION

1. Field of the Invention

The present invention generally relates to a configurable image processing system and a configurable image processing method thereof, in particular a configurable image processing system and configurable image processing method which can perform different image processing architecture by flexibly selecting needed pieces of logic hardware.

2. Description of the Related Art

Currently, an image processing technique, such as facial detection, usually applies a larger image processing architecture as shown in FIG. 1. FIG. 1 is a genealogical tree of a conventional image processing architecture, wherein each node 101 in the genealogical tree 10 represents a sub-processing architecture in an image processing architecture.

In an application of facial detection, data quantity processed by each node 101 might be huge. However, because of cost factor, only limited hardware resource is provided. Consequently, insufficient memory inside the hardware may occur while applying larger image processing architecture.

In addition, after completing an image processing architecture, hardware design specifically applying the image processing architecture must be prepared. For example, an integrated circuit (IC) is provided, and corresponding logic hardware is produced in the light of the sub-processing architecture corresponding to each node 101 and each genealogical tree path 102 in the genealogical tree 10.

The foregoing manner that accomplishes the algorithmic function of the image processing architecture can achieve the fastest image processing speed. However, if the image processing architecture must be changed in future, a new IC is designed and required in the light of changed image processing architecture with respect to a designer. The flexibility of hardware design level for the current image processing architecture is very low when the image processing architecture is changed.

### SUMMARY OF THE INVENTION

Based on the problems in the learned technique mentioned above, one objective of the present invention is to provide a configurable image processing system and a configurable image processing method thereof to solve the following problems that hardware resource is limited in the learned technique so that the huge image processing architecture could not be accomplished, and that it is necessary to specifically design different ICs in the light of different image processing architectures because of low flexibility for the deign level of hardware when the image processing architecture is changed.

According to the objective of the present invention, a configurable image processing system suitable to be applied for a predetermined image processing architecture is provided. This configurable image processing system comprises N pieces of logic hardware and a control module, wherein N is a positive integer greater than 1. Each piece of the logic hardware respectively corresponds to an algorithmic structure, and the control module connects to each piece of the logic hardware. The control module can selectively use the N pieces of logic hardware to make the algorithmic architecture corresponding to the applied pieces of logic hardware cascadedly combine at least one portion of the predetermined image processing architecture to perform the image processing.

According to another objective of the present invention, a configurable image processing method thereof suitable to be applied for a predetermined image processing architecture is provided. The configurable image processing method comprises the following steps: provide N pieces of logic hardware and each of which respectively corresponding to an algorithmic structure, wherein N is a positive integer greater than 1; and utilize the control module selectively applying the N pieces of logic hardware for making the algorithmic structure corresponding to the applied pieces of logic hardware cascadedly combine at least one portion of the predetermined image processing architecture to perform the image processing.

According to the other objective of the present invention, a configurable image processing system suitable to be applied for a predetermined image processing architecture is provided. The configurable image processing system comprises N pieces of logic hardware and a control module, wherein N is a positive integer greater than 1. Each piece of the logic hardware is respectively applied for performing image algorithmic sequences, wherein the algorithmic structure corresponding to each piece of the logic hardware is selectively applied for assembling one portion of the predetermined image processing architecture. The control module used for proceeding combination application sequences selectively applies the N pieces of logic hardware for making the algorithmic structure corresponding to the applied pieces of logic hardware assemble at least one portion of the predetermined image processing architecture to perform the image processing.

According to the above mentions, the configurable image processing system and the configurable image processing method thereof of the present invention have one or several advantages as follows:

(1) The present invention can assemble at least one portion of the predetermined image processing architecture to perform the image processing via the control module selectively utilizing N pieces of logic hardware, therefore the present invention may efficiently lower the number of used logic gates as compared with a manufactured IC based on the learned technique to accomplish the algorithmic function of the predetermined image processing architecture.

(2) The present invention can assemble the predetermined image processing architecture because each piece of the logic hardware, and the data quantity processed by each piece of the logic hardware is lower than that by the manufactured IC as compared with the learned technique. Therefore the present invention requires less hardware resource.

(3) The present invention can selectively apply different logic hardware, therefore when the designer wants to change the predetermined image processing architecture, the present invention just changes the applied pieces of logic hardware or the applied sequences of each piece of the logic hardware, and then the predetermined image processing architecture corresponding to above change would be accomplished soon. Thus, the present invention has larger flexible space for adjusting in hardware in order to accomplishing the predetermined image processing architecture as compared with a new manufactured IC based on the learned technique.

### BRIEF DESCRIPTION OF THE DRAWINGS

FIG. 1 is a genealogical tree of the learned image processing architecture;

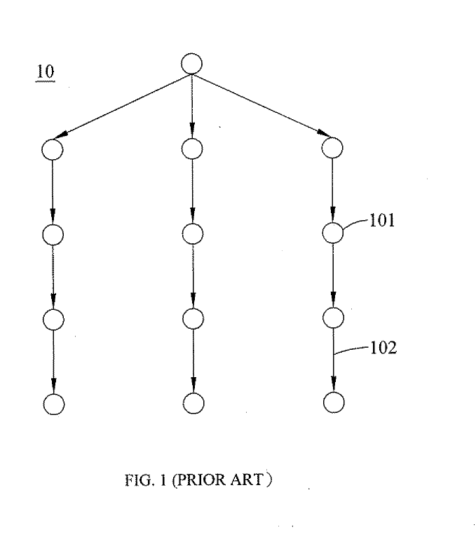

FIG. 2 is a block diagram of the first preferred embodiment of the configurable image processing system of the present invention;

FIG. 3 is a genealogical tree of the predetermined image processing architecture of the present invention;

FIG. 4 is the first schematic view of applied sequence for the logic hardware in the first preferred embodiment of the configurable image processing system of the present invention;

FIG. 5 is the second schematic view of applied sequence for the logic hardware in the first preferred embodiment of the configurable image processing system of the present invention;

FIG. 6 is a block diagram of the second preferred embodiment of the configurable image processing system of the present invention;

FIG. 7 is a schematic view of applied sequence for the logic hardware in the second preferred embodiment of the configurable image processing system of the present invention;

FIG. 8 is a flow chart of the configurable image processing method of the present invention; and

FIG. 9 is a flow chart of step S92 of the configurable image processing method of the present invention.

### DETAILED DESCRIPTION OF THE PREFERRED EMBODIMENTS

The combination image processing recording system of the present invention could be applied for a handy apparatus or an image grabbing device. For example: Tablet PC, Smartphone, Personal Digital Assistant, Ultra-Mobile PC, Digital Phone, Digital Camera, Digital Video Camera, Terminal Set and other electronic products, etc. But not to be limited only the stuff mentioned above.

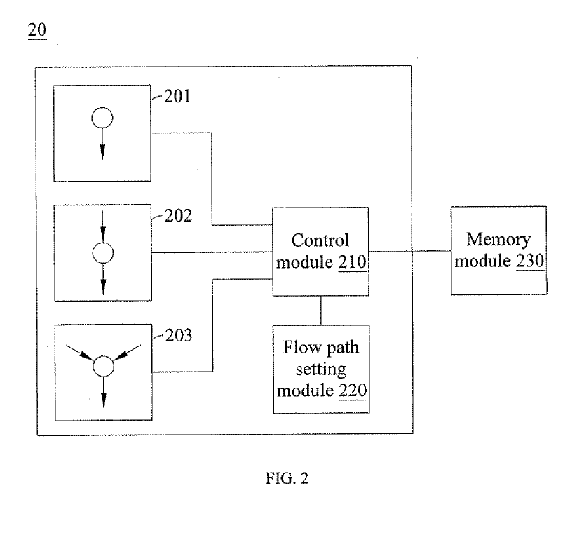

With reference to FIG. 2 for a block diagram about the first preferred embodiment of the configurable image processing system in accordance with the present invention, wherein the configurable image processing system 20 comprises a first piece of logic hardware 201, a second piece of logic hardware 202 and a third piece of logic hardware 203, a control module 210, a flow path setting module 220 and a memory setting module 230.

Wherein the control module 210 connects to the first piece of logic hardware 201, the second piece of logic hardware 202 and the third piece of logic hardware 203. Each of them individually has its function to accomplish different algorithmic architectures.

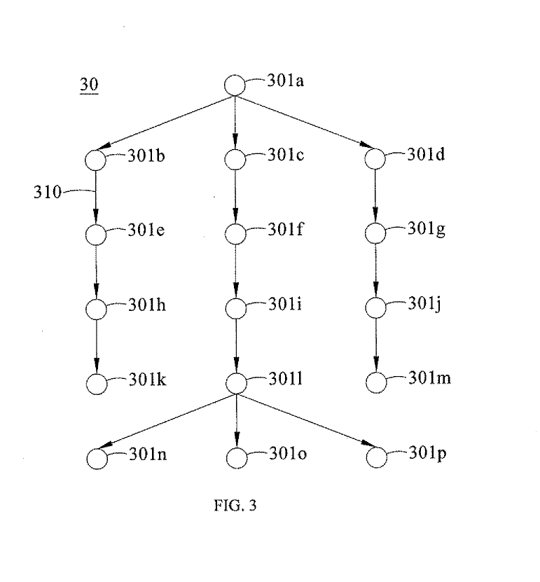

Detailedly speaking much more, with reference to FIGS. 2 and 3, FIG. 3 is a genealogical tree about the predetermined image processing architecture the present invention applies for. Wherein the genealogical tree 30 comprises a plurality of nodes 301a, 301b, 301c . . . 301p, each node can represent a sub-processing structure within the predetermined image processing architecture. That is, each of the nodes like 301a, 301b, 301c . . . 301p can be seen as a processing unit with algorithmic function. And the algorithmic structure which the first piece of logic hardware 201 corresponds to equals to a sub-processing structure of the node 301a. The algorithmic structure which the second piece of logic hardware 202 corresponds to equals to a sub-processing structure of the node 301b. The algorithmic structure which the second piece of logic hardware 203 corresponds to equals to a sub-processing structure of the node 301c, and the outputted results produced from the sub-processing structure of nodes 301b and 301c could be compared with each other. Wherein the detailed explanation about the comparison between the outputted results would be mentioned later in the specification.

One thing worthy to be mentioned is, the predetermined image processing architecture applied by the configurable image processing system of the present invention could determine the predetermined image processing architecture for the characteristics of face in this embodiment. But not to be limited only within above mention. In other embodiments of the present invention, the configurable image processing system could be applied for other predetermined image processing architectures as well such as the characteristics of palm prints, the pupil of the eye and the iris, etc.

And the sub-processing structure corresponding to the node 301a could perform the algorithmic processing of the facial detection towards the image and then output a processing result. The sub-processing structures corresponding to the nodes 301b-301c and 301d could perform the algorithm processing of the facial characteristics towards the image via the processing result from node 301a and then individually output another processing result. Deductively, node 301e, 301f . . . 301p could utilize the processing results from the node in previous step to perform the algorithmic processing of the facial characteristics and then individually output another processing result.

Wherein in the field of facial detection, the processing results may comprise the outputted feature values after detecting the characteristics on face. Understandingly, the compared outputs in the field of facial detection mentioned previously in the specification represent: if the sub-processing structure respectively corresponding to the nodes 301b and 301c output the feature values A and B after proceeding the facial detection towards the image, then the algorithmic structure corresponding to the third piece of logic hardware 203 could output a processing result A:B, which is the same as it is mentioned in previous paragraph that the node outputs the comparison between both the outputted results produced from the sub-processing architectures of nodes 301b and 301c respectively.

Therefore, when the user wants to assemble the predetermined image processing architecture in FIG. 3 by utilizing the pieces of logic hardware of the present embodiment, he can just simply use the control module 210 selectively repeatedly utilizing the first piece of logic hardware 201, the second piece of logic hardware 202 and the third piece of logic hardware 203 thus to completely assemble the genealogical tree 30 of the predetermined image processing architecture in FIG. 3.

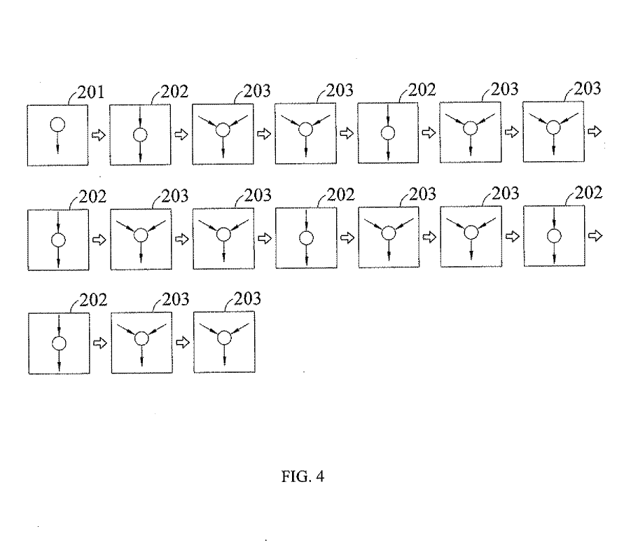

Detailedly speaking much more, with reference to FIG. 4 for the first schematic view of the application sequence in the logic hardware of the first preferred embodiment of the configurable image processing system in accordance with the present invention. Wherein the control module 210 can select the algorithmic architecture of the first piece of logic hardware 201 for accomplishing the sub-processing structure of the node 301a, then select the algorithmic structure of the piece of second logic hardware 202 for accomplishing the sub-processing structure of the node 301b, then repeat once again to select the algorithmic structure of the third piece of logic hardware twice to accomplish the sub-processing architectures for both nodes 301c and 301d.

Consecutively, the control module 210 utilizes four times of the following three items including the second piece of logic hardware 202, the third piece of logic hardware 203 and the third piece of logic hardware 203 once again in orders. The genealogical tree composed of nodes 301a, 301b . . . to 301m in the predetermined image processing architecture is accomplished.

Consecutively, the control module 210 utilizes one time of the following four items including the second piece of logic hardware 202, the second piece of logic hardware 202 once again, the third piece of logic hardware 203 and the third piece of logic hardware 203 once again in orders. The genealogical tree composed of nodes 301l, 301n, 301o, 301p in the predetermined image processing architecture is accomplished.

Therefore, the present embodiment could utilize three pieces of logic hardware to assemble a huge predetermined image processing architecture via the selectively repeated utilization of control module towards the first piece of logic hardware 201, the second piece of logic hardware 202 and the third piece of logic hardware 203. So, the embodiment can efficiently lower the number of used logic gates as compared with the ones based on the learned technique.

In addition, the logic hardware of the present embodiment is used to accomplish a sub-processing structure of the nodes, therefore the requirement for saving towards the inner memory is low. For example, for the image processing architecture such as the facial detection, if the data quantity of a node can attend 30K (1K equals to 1024 bytes), the huge image processing architecture in the learned technique comprises tens of nodes, that means the inner memory needs to have hundreds of K for satisfied usage. Understandingly, the present embodiment repeatedly utilizes the way of one piece of logic hardware following another, thus the inner memory with only 10K could accomplish the predetermined image processing architecture in FIG. 3. Therefore, the requirement of usage for the inner memory is decreased a lot.

Additionally, when the designer wants to adjust the originally applied predetermined image processing architecture, the designer can renewably select the first piece of logic hardware 201, the second piece of logic hardware 202 and the third piece of logic hardware 203 in orders to assemble different predetermined image processing architectures. Therefore, the configurable image processing system of the present invention could flexibly adjust to the applied pieces of logic hardware for desire in accordance with different predetermined image processing architecture instead of being accomplished by any other different manufactured Integrated Circuits (IC).

With reference to FIG. 2, the flow setting module 220 of the configurable image processing system 20 connects to the control module 210 and comprises a preset flow path. The control module 210 can selectively utilize the first piece of logic hardware 201, the second piece of logic hardware 202 and the third piece of logic hardware 203 in accordance with the preset flow path. Wherein the preset flow path can be actively set up by the user or the designer. For example, when the user wants to use different predetermined image processing architecture by inputting the corresponding processing flow path information of genealogical tree into the flow path setting module 220 in order to producing the determined flow path, then the control module could actively utilize the first logic piece of hardware 201, the second piece of logic hardware 202 and the third piece of logic hardware 203 to assemble the applied predetermined image processing architecture for desire in accordance with the predetermined flow path.

The memory module 230 connects to the control module 210 to provide the control module for saving or withdrawing the processing results from each logic unit. For example, a processing result of the first piece of logic hardware 201 outputs after performing an algorithmic processing towards the image would be temporarily saved in the memory module 230. And the second piece of logic hardware 202 would perform an algorithmic processing by utilizing the control module 210 withdrawing the processing results from the first piece of logic hardware 210.

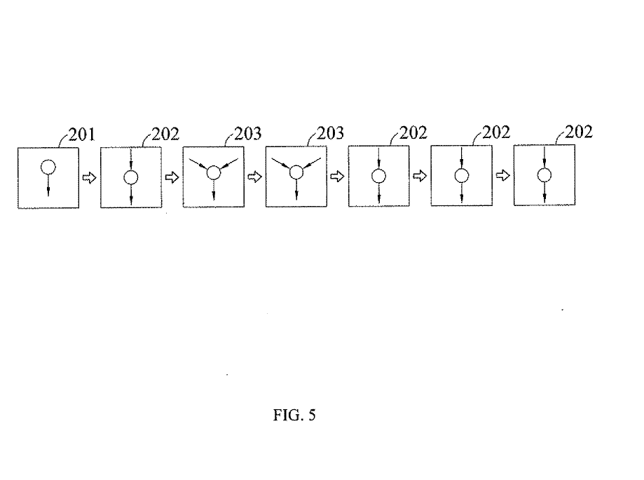

With reference to FIG. 5 for a second schematic view of the applied sequence for the logic hardware in the first preferred embodiment of the configurable image processing system in accordance with the present invention, wherein the combination module 210 could selectively repeatedly utilize the first piece of logic hardware 201, the second piece of logic hardware 202 and the third piece of logic hardware 203 to assemble a portion of the predetermined image processing architecture to perform the image processing. Detailedly speaking much more, the control module of the embodiment can just assemble a genealogical tree processing flow path of the predetermined image processing architecture for performing the image processing towards the image.

For example, in order to assembling the genealogical tree processing flow path 310 in genealogical tree 30 of the predetermined image processing architecture in FIG. 3, the control module 210 could first apply the first piece of logic hardware 210 for accomplishing the sub-processing structure of node 301a, then apply the second piece of logic hardware 202 for accomplishing the sub-processing structure of node 301b, and then apply the third piece of logic hardware 203 for accomplishing the sub-processing structure of node 301c, then finally produce a compared output. The information of this compared output comprises the first feature value produced by the second piece of logic hardware 202 performing image processing towards the image, and the second feature value produced by the third piece of logic hardware 203 performing image processing towards the image in accordance with the processing results from the first piece of logic hardware 201.

Consecutively, continuously utilize the third logic hardware to accomplish the sub-processing structure of node 301d and then produce a compared output in accordance with it. The information of the compared output comprises the third feature value produced by the third piece of logic hardware 203 performing the image processing towards the image in accordance with the processing results from the first piece of logic hardware 201 as well as the first and second feature values mentioned before.

The control module 210 can select the logic hardware applied later in accordance with the compared outputted information. Take the application of facial detection for example, the control module 210 can compare the values among the first, the second and the third feature values to actively apply the logic hardware from the first piece of logic hardware 201 to the third piece of logic hardware 203 for assembling the genealogical tree processing path 310.

Detailedly speaking much more, take the predetermined image processing architecture of the present embodiment for performing the image processing towards facial detection for example. And the genealogical tree processing path 310 represents identifying the characteristics on the flank towards the image. Meanwhile, the control module 210 can figure out the processing result as the feature value is within its range of the flank identification in accordance with the range the feature value corresponds to when identifying the characteristics on the flank.

Wherein the present embodiment takes the first feature value within the range of feature values of the flank identification for example. Meanwhile, the control module can then utilize the second piece of logic hardware 202 to receive the processing results comprising the first feature value in order to consecutively performing the algorithmic processing towards the image. And it again respectively connects and utilizes the second piece of logic hardware 202 twice. The second piece of logic hardware 202 at each utilization receives the processing result of the logic hardware from last step and in accordance with that to assemble the genealogical tree processing path 310 in order to identifying the characteristics on the flank towards the image.

Understandingly, the combination image processing architecture of the present preferred embodiment can selectively repeatedly utilize each piece of the logic hardware to assemble a portion of the predetermined image processing architecture (that is, the genealogical tree processing flow path 310) in order to perform the image processing towards the image. Therefore, because the present embodiment can perform necessary image processing towards the image instead of assembling a completely predetermined image processing architecture early, it can further decrease the requirement for the hardware resources.

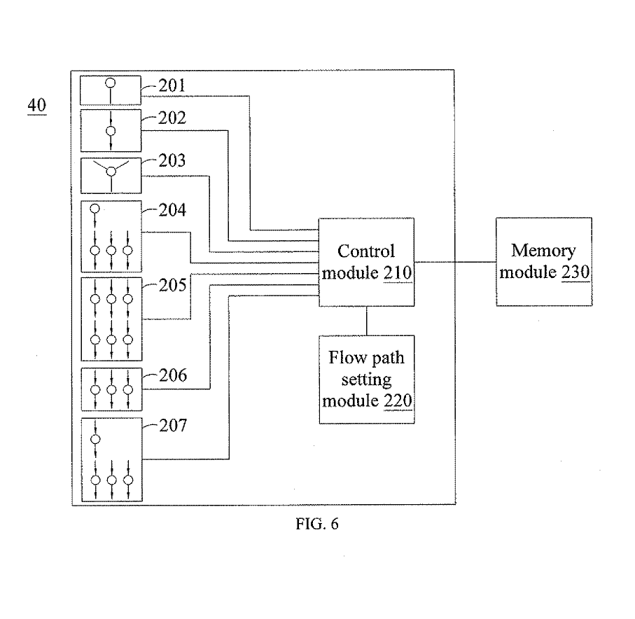

With reference to FIG. 6 for a block diagram of the second preferred embodiment of the configurable image processing system in accordance with the present invention, wherein the configurable image processing system 40 further comprises the fourth piece of logic hardware 204, the fifth piece of logic hardware 205, the sixth piece of logic hardware 206 and seventh piece of logic hardware 207 as compared with the first embodiment.

Wherein the control module 210 individually connects to each piece of the logic hardware from the first piece of logic hardware 201 to the seventh piece of logic hardware 207 and each piece of logic hardware individually comprises the function of performing different algorithmic structure. And the algorithmic structures corresponding to the fourth piece of logic hardware 204, the fifth piece of hardware 205, the sixth piece of hardware 206 and the seventh piece of hardware 207 within the present embodiment can accomplish the sub-processing structures of a plurality of nodes. That is, each piece of logic hardware from the fourth piece of hardware 204 to the seventh piece of hardware 207 can accomplish the same algorithmic function as that while multiple nodes assemble.

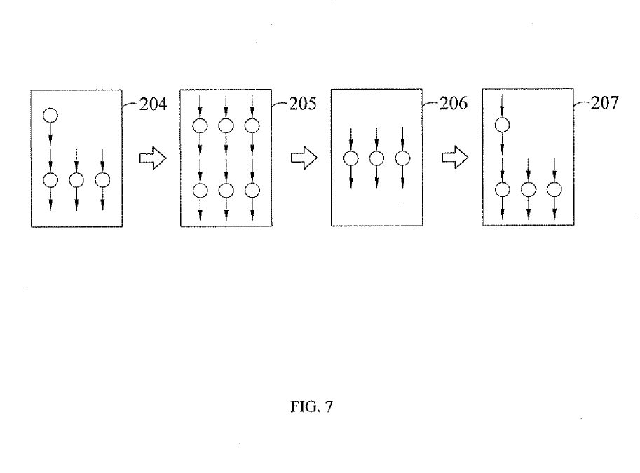

For example, with reference to FIG. 3 and FIG. 7. FIG. 7 is a schematic view of the applied sequence for each piece of the logic hardware in the second preferred embodiment of the configurable image processing system in accordance with the present invention. When the configurable image processing system needs to utilize the predetermined image processing architecture 30, it can utilize the control module 210 to use the algorithmic architecture of the fourth piece of logic hardware 204 first for accomplishing the assembled sub-processing structure composed of the nodes 301a, 301b, 301c and 301d.

Then, the control module 210 utilizes the algorithmic structure of the fifth piece of hardware logic hardware 205 again for accomplishing the assembled sub-processing structure composed of the nodes 301e, 301f . . . 301j and uses the algorithmic structure of the sixth piece of logic hardware 206 for accomplishing the assembled sub-processing structure composed of the nodes 301k, 301l and 301m. Finally, the control module 210 utilizes the algorithmic structure of the seventh piece of logic hardware 207 again for accomplishing the assembled sub-processing structure composed of the nodes 301l, 301n, 301o and 301p.

In the present embodiment, the algorithmic architecture of the logic hardware can accomplish the sub-processing structure of the plurality of nodes. Therefore, the present embodiment has faster speed in image processing as compared with the first embodiment does when it is within the range where the inner memory can assist.

It is worthy to be mentioned here is the accomplished sub-processing structure of the logic hardware in the present invention is not limited to be within the examples mentioned above. In other embodiments of the present invention, the sub-processing structure accomplished by the algorithmic structure of the logic hardware may comprise many other diverse types.

For example, in some portions of the embodiments in the present invention, the configurable image processing system can utilize classification flag, classification control and detect control to show up the function of both classification and architecture reassemblage. Detailedly speaking, the configurable image processing system could utilize the way of double digits coding to label the type after reassemblage and record it on the classification flag. The classification flag can be classified into two kinds of digit coding assemblage: the master class and the slave class. Both the classification and the cascade of data flow in each step can be fulfilled by letting the two kinds of digit coding change alternatively. For example, if the logic hardware can accomplish the processing structure of a plurality of cascaded nodes, the first node can be set up as a master class, the second node as a slave class and the third node as a master class, etc. and thus alternatively change classes deductively. If the logic hardware itself is a plural outputs class (such as the logic hardware 207), the outputted results are classified in orders automatically. And if the logic hardware is a concurrent output class (such as the logic hardware 206), the nodes in the logic hardware could be classified as master or slave class in accordance with the gotten inputted results.

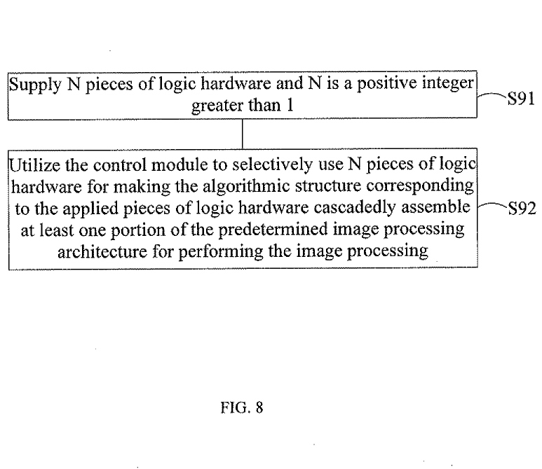

With reference to FIG. 8 for a flow chart of the configurable image processing method in accordance with the present invention, wherein the configurable image processing method is suitable to be applied for a predetermined image processing architecture, the method comprises the following steps:

In step S91 supply N pieces of logic hardware and N is a positive integer greater than 1. Wherein each piece of logic hardware respectively corresponds to different algorithmic structures that can be applied for accomplishing some portions of sub-architectures within the predetermined image processing architecture.

In step S92 utilize the control module to selectively use N pieces of logic hardware for making the algorithmic structure corresponding to the applied pieces of logic hardware cascadedly assemble at least one portion of the predetermined image processing architecture for performing the image processing.

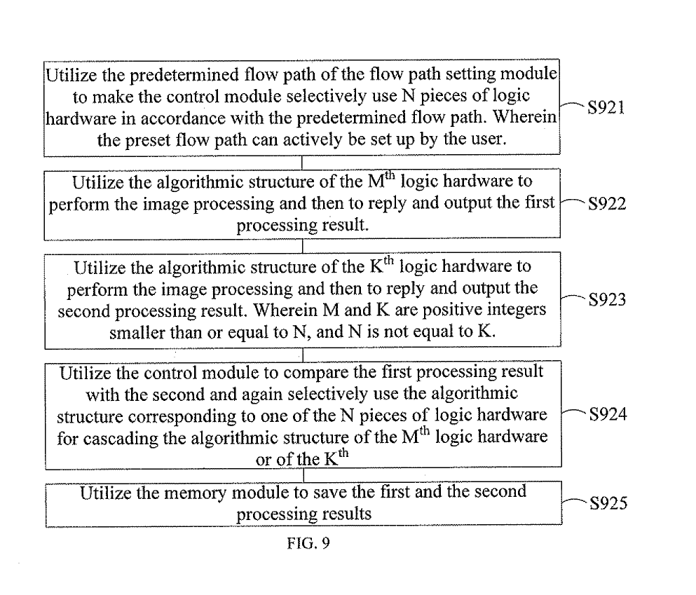

Then with reference to FIG. 9 for a flow chart of step S92 the configurable image processing method in accordance with the present invention, wherein step S92 further comprises:

In step S921 utilize the predetermined flow path of the flow path setting module to make the control module selectively use N pieces of logic hardware in accordance with the preset flow path. Wherein the predetermined flow path can actively be set up by the user.

In step S922 utilize the algorithmic structure of the M^{th} logic hardware to perform the image processing and then to reply and output the first processing result.

In step S923 utilize the algorithmic architecture of the K^{th} logic hardware to perform the image processing and then to reply and output the second processing result. Wherein M and K are positive integers smaller than or equal to N, and N is not equal to K.

In step S924 utilize the control module to compare the first processing result with the second and again selectively use the structure architecture corresponding to one of the N pieces of logic hardware for cascading the algorithmic architecture of the M^{th} logic hardware or of the K^{th}.

In step S925 utilize the memory module to save the first and the second processing results.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A configurable image processing system suitable for applying in a predetermined image processing architecture, comprising:
N pieces of logic hardware, each piece of the logic hardware respectively corresponding to an algorithmic structure, wherein N is a positive integer greater than 1; and
a control module connected to each piece of the logic hardware and selectively applying the N pieces of logic hardware so that the algorithmic structure corresponding to the applied pieces of logic hardware are cascaded to form at least one portion of the predetermined image processing architecture, thereby performing an image process.

2. The configurable image processing system of claim 1, further comprising a flow path setting module connected to the control module and comprising a preset flow path, wherein the control module selectively applies the N pieces of logic hardware based on the preset flow path.

3. The configurable image processing system of claim 2, wherein the flow path setting module allows to be manipulated by a user to set the preset flow path.

4. The configurable image processing system of claim 1, wherein the at least one portion of the predetermined image processing architecture comprises the algorithm structure corresponding to both an M^{th} and a K^{th} logic hardware, and the control module compares a first processing result outputted from image processing that is performed by the algorithm structure of the M^{th} logic hardware with a second processing result outputted from that of the K^{th} logic hardware and then selectively applied the algorithm structure corresponding to one of the N pieces of logic hardware, and the algorithm structure that is applied is cascaded to the algorithm structure of the M^{th} or the K^{th} logic hardware, wherein M and K are positive integers smaller than or equal to N, and N is not equal to K.

5. A configurable image processing method suitable for applying a predetermined image processing architecture, comprising the following steps:
providing N pieces of logic hardware, each pieces of the logic hardware respectively corresponding to an algorithm structure, wherein N is a positive integer larger than 1; and
utilizing a control module to selectively apply the N pieces of logic hardware so that the algorithm structure corresponding to the applied logic hardware are cascaded to form at least one portion of the predetermined image processing architecture, thereby performing image processing.

6. The configurable image processing method of claim 5, wherein the step of utilizing the control module to selectively apply the N pieces of logic hardware further comprises:
generating a preset flow path by a flow path setting module such that the control module selectively applies the N pieces of logic hardware based on the preset flow path.

7. The configurable image processing method of claim 5, wherein the predetermined image processing architecture is composed of a plurality of processing nodes, and each algorithm structure respectively has an algorithmic arranged for executing at least one of the processing nodes.

8. The configurable image processing method of claim 5, wherein the at least one portion of the predetermined image processing architecture comprises the algorithm structure corresponding to both an M^{th} and a K^{th} logic hardware, and the steps of utilizing the control module to selectively apply the N pieces of logic hardware further comprise:
using the algorithm structure of the M^{th} logic hardware to perform image processing and output a first processing result;
using the algorithm structure of the K^{th} logic hardware to perform image processing and output a second processing result; and
using the control module to compare the first processing result with the second processing result to selectively apply the algorithm structure corresponding to one of the N pieces of logic hardware to cascade the algorithm structure of the M^{th} or the K^{th} logic hardware, wherein M and K are positive integers that are smaller than or equal to N, and M is not equal to K.

9. A configurable image processing system suitable for applying a predetermined image processing architecture, the configurable image processing system comprising:
N pieces of logic hardware for respectively executing an image algorithm sequence, wherein to an algorithm structure each pieces of the logic hardware corresponds is selectively applied to form at least one portion of the predetermined image processing architecture; and
a control module for executing a combination application sequence to selectively apply the N pieces of logic hardware such that the algorithm structure of applied pieces of the logic hardware are cascaded to form at least one portion of the predetermined image processing architecture, thereby performing image processing.

10. The configurable image processing system of claim 9, further comprising a flow path setting module for providing a preset flow path such that the control module selectively applies the N pieces of logic hardware based upon the preset flow path.

11. The configurable image processing system of claim 9, wherein the at least one portion of the configurable image processing system comprises the algorithm structures corresponding to both an M^{th} and a K^{th} logic hardware, and the control module executes a comparison sequence to compare a first processing result outputted from image processing that is performed by the algorithm structure of the M^{th} logic hardware with a second processing result outputted from that of the K^{th} logic hardware and then selectively applies the algorithm structure corresponding to one of the N pieces of logic hardware, and the algorithm structure that is applied is cascaded to the algorithm structure of the M^{th} or the K^{th} logic hardware, wherein M and K are positive integers smaller than or equal to N, and M is not equal to K.
